(19) United States
(12) Patent Application Publication
(10) Pub. No.: US 2008/0074512 A1
(43) Pub. Date: Mar. 27, 2008

(54) Digital image sensor and noise cancellation operation method

(75) Inventors: Yu-Chen Sung, Hsin-Tien City (TW); Ming-Chien Tsou, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(73) Assignee: LITE-ON SEMICONDUCTOR CORPORATION

(21) Appl. No.: 11/527,462

(22) Filed: Sep. 27, 2006

(51) Int. Cl. H04N 5/217

(52) U.S. Cl. 348/241

(57) ABSTRACT

A digital image sensor and noise cancellation operation method reduces noise of an analog sensor circuit inside a digital image sensor and simplifies the complex design of an analog/digital signal of the prior art. The present invention provides a novel digital image sensor for converting at least one analog noise signal to at least one digital noise signal outputted via an analog/digital converter. The digital noise signal is written to a memory and compared with the original digital image signal for generating at least one image signal clearly. The digital image sensor of the present invention is replaced with an analog correlated double sampling circuit for canceling out noise.

### BACKGROUND OF THE INVENTION

1. Field of the Invention

The present invention is a digital image sensor and noise cancellation operation method. More specifically, it is related to a CMOS digital image sensor having a noise interference and noise cancellation operation method.

2. Description of Related Art

Charged-coupled device (CCD) or complementary metal-oxide semiconductor (CMOS) image sensor (CIS) are generally used on digital camera in the field of digital image technology. CCD suffers from a disadvantage of requiring a plurality of power supply circuits, a high driving voltage and high power consumption. However, the CIS has a number of advantages over the CCD, including low driving voltage, low power consumption, fabrication from a standard CMOS process, and high integration. Furthermore, the size of pixels on a CMOS component can be smaller, compared to charged-coupled device, for providing higher resolution.

Despite the advances of CIS technology, certain remaining problems prevent their widespread acceptance. One such problem is “KTC” noise introduced in CMOS pixels during a reset operation. KTC noise which is obtained using an equation (vkTC=(kT/C)^{1/2}) is generated at a timing when a node of the transistor (or photoelectric conversion element) is opened from the short condition to a predetermined reset voltage. Here, k is a Boltzmann constant, T is an absolute temperature and C is the full capacitance of the transistor (or photoelectric conversion element).

KTC noise is generated randomly so it is difficult to remove from an image. However, the KTC noise will reduce the signal to noise ratio of the output image signal.

Prior art attempts to combat KTC noise focused on varying the structure of the pixel, or compensating or reducing the bandwidth available for KTC noise to exist. TW patent no. I233299 proposed a “Method and apparatus for KTC noise canceling in a linear CMOS image sensor”. This patent discloses a method of detecting a pixel signal from a pixel. The method comprises first capturing a first black reference signal from the pixel prior to the pixel starting an integration period. Next, after completion of the integration period, a pixel signal is captured. Next, a second black reference signal is captured following completion of the integration period. Finally, the first black reference signal, second black reference signal, and pixel signal is outputted.

TW patent no. 200303141 has proposed a “CMOS image sensor”. The CMOS image sensor comprises a voltage control circuit 16a, a pixel circuit structure 10a, a part of a differential amplifier 12a of a line and a correlated double sampling circuit 14a that corresponds to the differential amplifier 12a. FIG. 1 shows a schematic diagram of a CMOS image sensor circuit in accordance with the prior art.

The voltage control circuit 16a controls a reset signal (RST) to input the pixel circuit structure 10a. A photoelectric conversion element D11 and a reset transistor M11 photo sensor circuit of the pixel circuit structure generate KTC noise. High frequencies of KTC noise are reduced when the voltage of the reset signal (RST) is inputted through a low-pass filter. The low-pass filter consists of an open resistor belonging to the reset transistor M11 and a parasitic capacitance of the photoelectric conversion element D11. The voltage control circuit 16a controls the voltage of the reset signal (RST) such that a cut-off frequency of the low-pass filter does not overlap an operation band limitation of the differential amplifier 12a. As such, KTC noise on a bandwidth is reduced.

In addition, the correlated double sampling circuit 14a is deposited on output side of the differential amplifier 12a. The reset noise signal (RST) is cancelled when the reset noise signal (RST) status is changed from on to off.

The output signal quality of the correlated double sampling circuit 14a suffers a number of defects which can be improved upon. However, the output signal readout is affected by random noise and the design of the integrated circuit because it utilizes an analog signal process.

### SUMMARY OF THE INVENTION

An object of the present invention is to provide a CMOS digital image sensor having noise interference and noise cancellation methods to solve problems caused by random noise and the design of the integrated circuit when the analog signal is readout in prior art.

In one embodiment, the digital image sensor comprises a photo sensor circuit, an analog-to-digital signal conversion circuit, a first memory unit, a second memory unit, and a digital logic correcting circuit. The photo sensor circuit generates at least one sample-and-hold analog signal. The analog-to-digital signal conversion circuit converts the sample-and-hold analog signals to a digital signal. The first memory unit and the second memory unit stores at least one digital reset image signal of the digital signals and at least one digital image signal of the digital signals separately. The digital logic correcting circuit receives the digital reset noise signals and the digital image signals and performs a signal correcting process to output at least one image sensor signal.

As a operation method for noise cancellation of a digital image sensor, comprising steps of: sampling at least one sample-and-hold signal; converting the sample-and-hold signal to at least one digital signal; separating the digital signal to at least one digital reset noise signal and at least one image signal; storing the digital reset noise signal and the image signal on a first memory unit and a second memory unit separately; using a digital logic correcting circuit to compare the digital reset noise signals with the digital image signals; and outputting at least one image sensor signal after it has been compared with the digital reset noise signals and the digital image signals.

The present invention uses digital signals rather than analog signals to replace the original correlated double sampling circuit for canceling KTC noise in prior art. The present invention has the advantages of lower power consumption, higher operating speed, and a lower manufacturing cost. The present invention can be easily integrated on a system on a chip (SOC).

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of a CMOS image sensor circuit in accordance with the prior art;

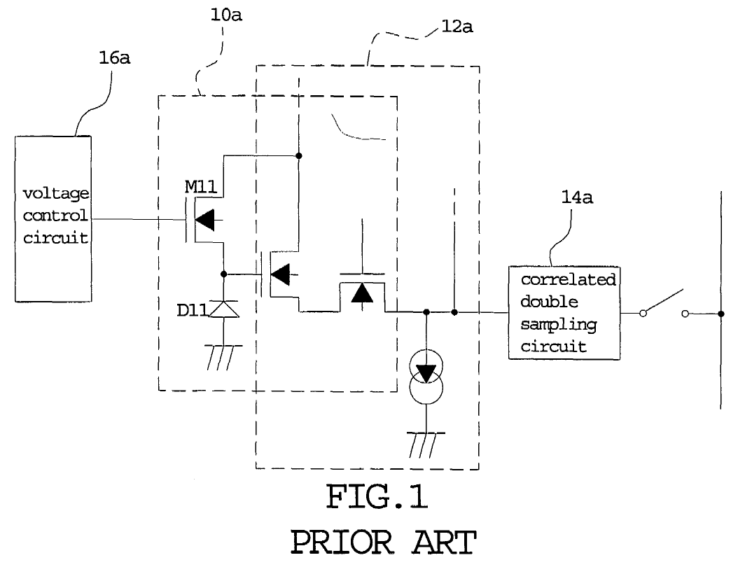

FIG. 2 is a schematic diagram of a digital image sensor in accordance with the present invention;

FIG. 3 is a circuit schematic diagram of a digital image sensor in accordance with the present invention;

FIG. 4 is a first embodiment-timing diagram of a digital image sensor in accordance with the present invention;

FIG. 5 is a second embodiment-timing diagram of a digital image sensor in accordance with the present invention; and

FIG. 6 is a chart of the operation method of a digital image sensor in accordance with the present invention.

### DETAILED DESCRIPTION OF PREFERRED EMBODIMENTS

The digital image sensor has a high operating speed and is easily integrated to implement various image application products. The objects of the present invention is to eliminate the noise of an analog sensor circuit inside a digital image sensor and simplify the complex design of an analog/digital and raise the performance of the digital image sensor, reduce its cost and shorten its development time.

In the prior art, the analog sensor circuit inside the digital image sensor utilizes a correlated double sampling (CDS) circuit to cancel noise from outside and integrates a circuit-manufacturing process. The application field includes all necessary photoelectric elements to a read static graphic and dynamic image process device, such as scanners, mobile phones with cameras, micro-cameras, or monitors. In the SOC, the correlated double sampling circuit inside of the digital image sensor can obtain good output signal quality. However, the output signal readout is affected by random noise and the design of the integrated circuit because it utilizes an analog signal process.

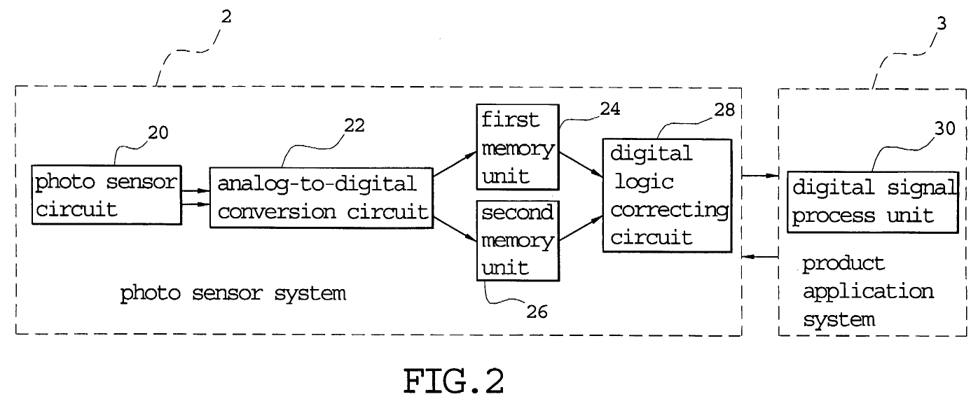

Reference is made to FIG. 2, which shows a schematic diagram of a digital image sensor in accordance with the present invention. An image signal is transmitted from a photo sensor system 2 to a product application system 3 for executing digital processes. The digital image sensor includes a plurality of a photo sensor circuit 20 that generates at least one sample-to-hold analog signal, wherein the sample-to-hold analog signals are at least one pixel. For example, the photo sensor circuit 20 implements can be a CMOS photo sensor array. An analog-to-digital conversion circuit 22 that receives the sample-to-hold analog signals to convert at least one digital signal. Sampling at least one digital reset noise signal and at least one digital image signal from the digital signals separately in accordance with various sampling time cycles.

The digital reset noise signals are stored on a first memory unit 24 and the digital image signals are stored on a second memory unit 26. The first memory unit 24 or the second memory unit 26 could be a section of a memory. Herein, the memory 24,26 may be a register or a non-volatile memory. The first memory unit 24 outputs the digital reset noise signals and the second memory unit 26 outputs the digital image signals. A digital logic correcting circuit 28 receives the digital reset noise signals and the digital image signals for executing a signal correcting process and outputs at least one image sensor signal to a digital process unit 30.

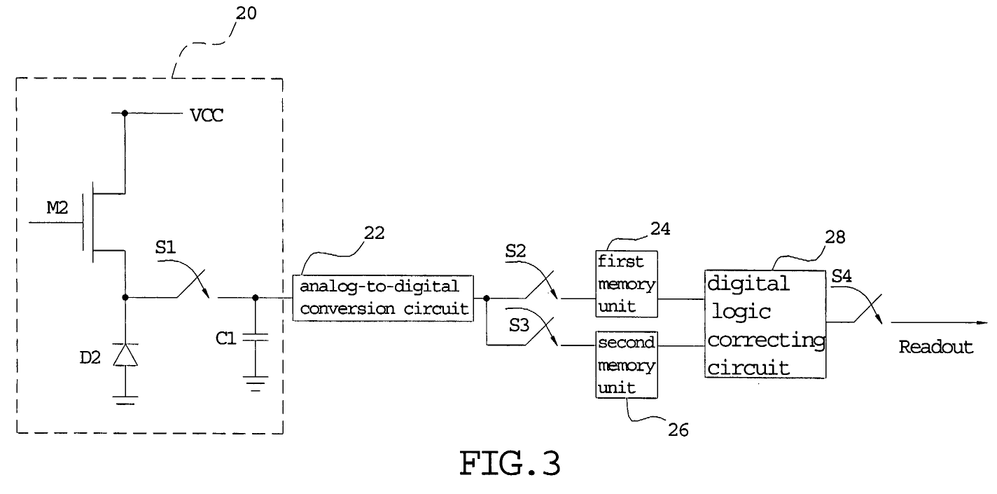

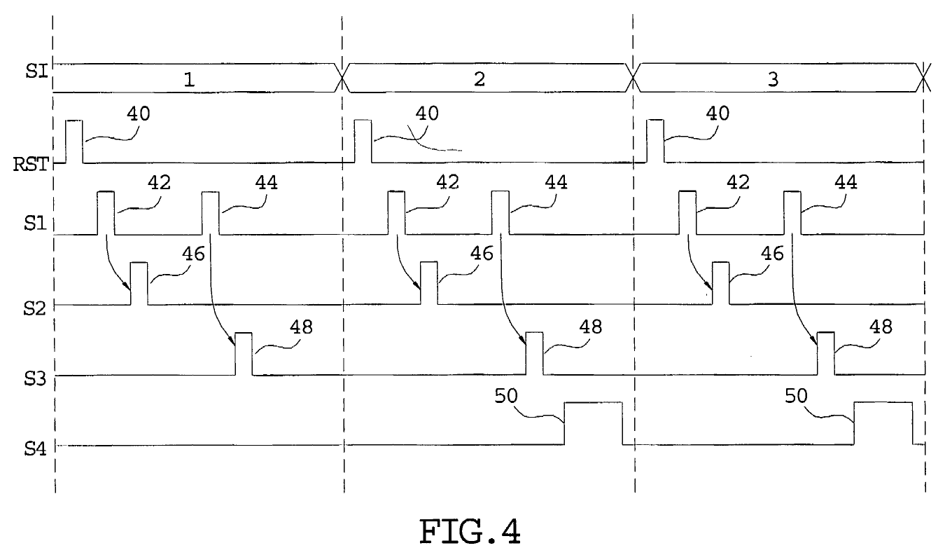

Reference is made to FIG. 3 and FIG. 4. FIG. 3 shows a circuit schematic diagram of a digital image sensor in accordance with the present invention. FIG. 4 shows a first embodiment-timing diagram of a digital image sensor in accordance with the present invention. In the first time cycle SI, the photo sensor circuit 20 receives a reset signal 40 from outside, wherein the reset signal 40 waveform is shown in FIG. 4. A voltage of the reset signal 40 generates noise on the photo sensor circuit 20 through a reset transistor M2 and parasitic capacitance (not shown) parallel with a photoelectric conversion element D2. The reset transistor M2 outputs analog signals, including the KTC noise, random noise and other noise signals, which are then stored on a sample capacitance C1.

The sample-to-hold analog signals waveform is obtained through the sample-to-hold switch S1 to charge/discharge the sample capacitance C1.

The sample-to-hold switch S1 is turned off momentarily and obtains at least one analog reset noise signal 42. The analog reset noise signals 42 are transmitted to the analog-to-digital conversion circuit 22 for converting at least one digital reset noise signal 46. The digital reset noise signals 46 are stored on the first memory unit 24 via a first readout switch S2 being turned on and off. The sample-to-hold switch S1 is turned off so it is in a stable condition so that the sample capacitance C1 is finished charging and obtains at least one analog image signal 44. The analog image signals 44 are transmitted to the analog-to-digital conversion circuit 22 for converting at least one digital image signal 48. The digital image signals 48 are stored on the second memory unit 26 via a second readout switch S3 being turned on and off. The digital image signal 48 includes the digital reset noise signals 46.

The digital reset noise signals 46 and digital image signals 48 transmit to the digital logic correcting circuit 28. The digital logic correcting circuit 28 generates at least one image sensor signal through a third readout switch S4, then the digital logic correcting circuit 28 output end can catch clearly the image sensor signals 50. The digital logic correcting circuit 28 shown in this embodiment is a subtractor. However, the digital logic correcting circuit 28 is not limited to this kind. The digital logic correcting circuit 28 includes any digital logic circuit that is capable of achieving cancellation of the digital reset noise signals.

FIG. 4 shows the image sensor signals 50 after it has finished outputting during the second time cycle. If the digital logic correcting circuit 28 is operating, it must wait until the next analog reset noise signal arrives. That is, the digital logic correcting circuit 28 executes and digitizes the digital image signals 48 of the first time cycle and the digital reset noise signals 46 of the second time cycle for outputting the image sensor signals 50.

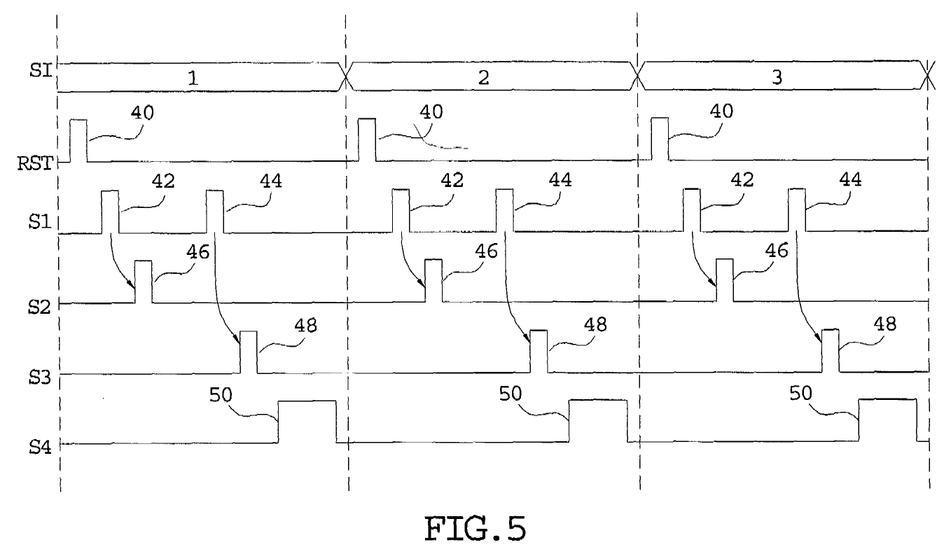

However, the image sensor signals 50 can also operate during the same time cycle. That means that the digital logic correcting circuit 28 execute and digitize the digital image signals 48 of the first time cycle and the digital reset noise signals 46 of the first time cycle for outputting the image sensor signals 50 directly, as is shown in FIG. 5.

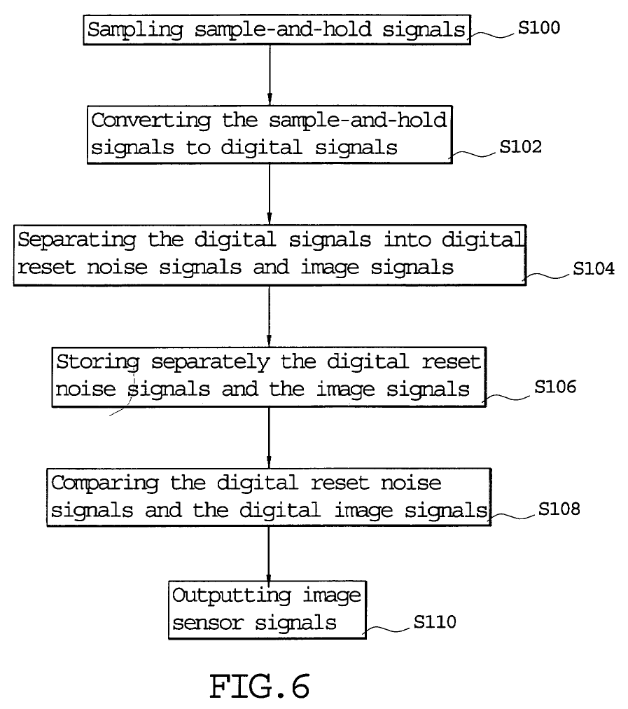

Reference is made to FIG. 6, which shows a chart of the operation method of a digital image sensor in accordance with the present invention. The photo sensor circuit samples at least one sample-and-hold signal (S100). The analog-to-digital signal conversion circuit converts the sample-and-hold signals to at least one digital signal via an analog-to-digital (S102). Next, separating the digital signals into at least one digital reset noise signal and at least one image signal in accordance with various sampling time cycles (S104). Then, to store separately the digital reset noise signals and the image signals on a first memory unit and a second memory unit (S106). Using a digital logic correcting circuit to compare the digital reset noise signals and the digital image signals (S108). Finally, outputting at least one image sensor signal after comparison with the digital reset noise signals and the digital image signals (S110).

The present invention samples the entire digital signals multiple times. The digital image sensor outputs a first digital signal, wherein the first digital signal includes the noise signal of a sensor signal circuit and other signals (such as offset, noise . . . etc). In addition, the real circuit sensor signal outputs a second digital signal. The first digital signal and the second digital signal write to a memory. The digital logic circuit executes the digital correcting process for the first digital signal and the second digital signal and outputs a clear image sensor signal.

The analog signal converts to the digital signal and writes to memory. It then compares the digital signal after it has been converted and the original digital image signal to cancel the KTC noise. This simple digital manner is used to replace the correlated double sampling circuit in the prior art. The present invention reduces the size of the circuit area, lowers power consumption, improves operation speed, improves image quality and can be integrated on the SOC easily.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. A digital image sensor, comprising:
a photo sensor circuit for generating at least one sample-and-hold analog signal;
an analog-to-digital signal conversion circuit for converting the sample-and-hold analog signal to at least one digital signal;
a first memory unit connected with the analog-to-digital signal conversion circuit for storing at least one digital reset noise signal of the digital signal;
a second memory unit connected with the analog-to-digital signal conversion circuit for storing at least one digital image signal of the digital signal; and
a digital logic correcting circuit receiving the digital reset noise signal and the digital image signal for executing a signal correcting process and outputting at least one image sensor signal.

2. The digital image sensor of claim 1, further comprising a digital signal process unit for digitizing the image sensor signal.

3. The digital image sensor of claim 1, wherein the first memory unit or the second memory unit is a section of a memory.

4. The digital image sensor of claim 3, wherein the memory is a register or a non-volatile memory.

5. The digital image sensor of claim 1, further comprising a first read switch connected to the first memory unit for controlling the digital reset signal timing.

6. The digital image sensor of claim 1, further comprising a second read switch connected to the second memory unit for controlling the digital image signal timing.

7. The digital image sensor of claim 1, wherein the digital logic correcting circuit is a subtractor.

8. A operation method for KTC noise cancellation of a digital image sensor, comprising:
sampling at least one sample-and-hold signal;
converting the sample-and-hold signal to at least one digital signal;
separating the digital signals into at least one digital reset noise signal and at least one image signal;
storing separately the digital reset noise signal and the image signal on a first memory unit and a second memory unit;
using a digital logic correcting circuit to compare the digital reset noise signal and the digital image signal; and
outputting at least one image sensor signal after comparing the digital reset noise signal and the digital image signal.

9. The operation method of claim 8, wherein the first memory unit or the second memory unit is a section of a memory.

10. The operation method of claim 8, wherein the memory is a register or a non-volatile memory.

11. The operation method of claim 8, wherein the digital logic correcting circuit is a subtractor.

12. The operation method of claim 8, wherein the image sensor signal is generated from the digital logic correcting circuit for canceling the digital reset noise signals.
